(19) United States
(12) Patent Application Publication
(10) Pub. No.: US 2019/0392463 A1
(43) Pub. Date: Dec. 26, 2019

(54) METHODS, SYSTEMS, APPARATUSES AND DEVICES FOR FACILITATING PROVISIONING OF STATISTICAL DATA FOR A QUESTIONNAIRE

(71) Applicant: Adalberto Samaia, The Woodlands, TX (US)

(72) Inventor: Adalberto Samaia, The Woodlands, TX (US)

(21) Appl. No.: 16/452,246

(22) Filed: Jun. 25, 2019

Related U.S. Application Data
(60) Provisional application No. 62/689,636, filed on Jun. 25, 2018.

(51) Int. Cl. G06Q 30/02; G06F 16/901; G09B 7/02

(52) U.S. Cl. CPC G06Q 30/0203; G09B 7/02; G06F 16/9024

(57) ABSTRACT

Disclosed herein is a system for facilitating provisioning of statistical data for a questionnaire. Accordingly, the system may include a communication device configured for receiving questionnaire data from at least one administrator device. Further, the communication device may be configured for transmitting at least one questionnaire to one or more participant devices associated with one or more participants. Further, the communication device may be configured for receiving response data corresponding to the at least one questionnaire from the one or more participant devices. Further, the communication device may be configured for transmitting a visual statistical representation to the at least one administrator device. Further, the system may include a processing device configured for generating the at least one questionnaire based on the questionnaire data. Further, the processing device may be configured for analyzing the response data to generate the visual statistical representation for the at least one questionnaire.

The current application claims a priority to the U.S. Provisional Patent application Ser. No. 62/689,636 filed on Jun. 25, 2018.

### FIELD OF THE INVENTION

Generally, the present disclosure relates to the field of data processing. More specifically, the present disclosure relates to methods, systems, apparatuses and devices for facilitating provisioning of statistical data for a questionnaire.

### BACKGROUND OF THE INVENTION

Currently, gathering information from multiple individuals has gained importance. Companies use surveys to gain insights, and opinions from individuals about products, services, and other individuals through surveys, polls, and reviews.

Further, even in academic, and professional circles, receiving information from multiple individuals, such as students, and trainees, for the purpose of education and training, is essential.

Accordingly, systems that may include the feature of creation and transmission of questionnaires, and receiving responses from multiple users, and generating statistical data and visualizations corresponding to responses received from multiple mobile devices do not exist.

Further, systems that may include the feature of creation and updating of statistical data and visualizations corresponding to responses received from multiple mobile devices in real time do not exist.

Therefore, there is a need for improved methods, systems, apparatuses and devices for facilitating provisioning of statistical data for a questionnaire that may overcome one or more of the above-mentioned problems and/or limitations.

### BRIEF SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating provisioning of statistical data for a questionnaire, in accordance with some embodiments. Accordingly, the method may include receiving, using a communication device, questionnaire data from at least one administrator device associated with at least one administrator. Further, the method may include generating, using a processing device, at least one questionnaire based on the questionnaire data. Further, the method may include transmitting, using the communication device, the at least one questionnaire to one or more participant devices associated with one or more participants. Further, the method may include receiving, using the communication device, response data corresponding to the at least one questionnaire from the one or more participant devices. Further, the method may include analyzing, using the processing device, the response data to generate a visual statistical representation for the at least one questionnaire. Further, the method may include transmitting, using the communication device, the visual statistical representation to the at least one administrator device.

Further disclosed herein is a system for facilitating provisioning of statistical data for a questionnaire, in accordance with some embodiments. Accordingly, the system may include a communication device configured for receiving questionnaire data from at least one administrator device associated with at least one administrator. Further, the communication device may be configured for transmitting at least one questionnaire to one or more participant devices associated with one or more participants. Further, the communication device may be configured for receiving response data corresponding to the at least one questionnaire from the one or more participant devices. Further, the communication device may be configured for transmitting a visual statistical representation to the at least one administrator device. Further, the system may include a processing device configured for generating the at least one questionnaire based on the questionnaire data. Further, the processing device may be configured for analyzing the response data to generate the visual statistical representation for the at least one questionnaire.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram representation of a system to facilitate provisioning of statistical data for a questionnaire, in accordance with some embodiments.

FIG. 3 is a flowchart of a method to facilitate provisioning of statistical data for a questionnaire, in accordance with some embodiments.

FIG. 4 is a flowchart of a method to facilitate provisioning of visual statistical representation in real-time, in accordance with some embodiments.

FIG. 5 is a flowchart of a method to facilitate provisioning of visual statistical representation based on correctness of response, in some embodiments.

FIG. 6 is a block diagram representation of a system to facilitate obtaining statistical data for at least one questionnaire at administrator side, in accordance with some embodiments.

FIG. 7 is a flowchart of a method to facilitate obtaining statistical data for at least one questionnaire at administrator side, in accordance with some embodiments.

FIG. 8 is a flowchart of a method to facilitate provisioning of visual statistical representation in real-time at administrator side, in accordance with some embodiments.

FIG. 9 is a block diagram representation of a system to facilitate provisioning of responses for at least one questionnaire at a client side, in accordance with some embodiments.

FIG. 10 is a flowchart of a method to facilitate provisioning of responses for at least one questionnaire at a client side, in accordance with some embodiments.

FIG. 11 is a flowchart of a method to facilitate provisioning of visual statistical representation for the at least one questionnaire at client side, in accordance with some embodiments.

FIG. 12 is a flowchart of a method to facilitate provisioning of visual statistical representation in real-time at client side, in accordance with some embodiments.

FIG. 13 is a flowchart of a method to facilitate presenting the visual statistical representation in real-time at client side, in accordance with some embodiments.

FIG. 14 is a flowchart of a method to facilitate creation, transmission, and receipt of questionnaires, and answers thereof to and from multiple mobile devices, and generate real-time statistical data based on the received answers, in accordance with some embodiments.

FIG. 15 is a flowchart of a method to validate the answers provided by one or more participants, in accordance with some embodiments.

FIG. 16 is a block diagram of a system to facilitate creation, transmission, and receipt of questionnaires, and answers thereof to and from multiple mobile devices, and generate real-time statistical data based on the received answers, in accordance with some embodiments.

FIG. 17 is a screenshot of an exemplary user interface for a web-based application configured to provide one or more questionnaires to one or more participants, in accordance with some embodiments.

FIG. 18 is a screenshot of an exemplary user interface for a web-based application configured to provide one or more questionnaires to one or more participants, in accordance with some embodiments.

FIG. 19 is a screenshot of an exemplary user interface for a web-based application at least one administrator, in accordance with some embodiments.

FIG. 20 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of provisioning of statistical data for a questionnaire, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure includes methods, systems, apparatuses and devices for facilitating provisioning of statistical data for a questionnaire. Further, the system to facilitate creation, transmission, and receipt of questionnaires, and answers thereof to and from multiple mobile devices, and generate real-time statistical data based on the received answers may be called as ConTesta and may allow an administrator to ask for opinions from other individuals in real time, regardless the size of the group and the type of a questionnaire.

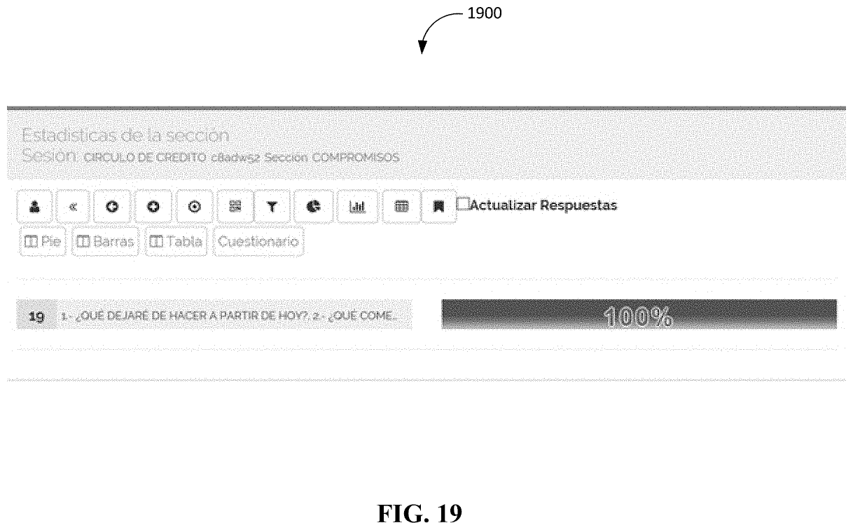

The system may include two modules, participant, and administrator. Administrator module may include two sub-modules, namely questionnaire, and Control Panel. The participant module may be accessed through web or an application. Further, the questionnaire module may include sessions containing one or more options, sections containing one or more questions, and questions that may have a different format. Section might be configured to run automatically and independent of a user or for multiple users to review and answer a same question at the same time. Further, FIG. 19 shows an exemplary UI illustrating the administrator module. Further, the session may run automatically, and the section may switch to the next one once the questions of a particular section may have been answered. The answers may be evaluated automatically generating an individual score

Further, once a section is activated and all participants of the session and all questions of the session are answered, a visual representation of the session may appear and may include a number of persons that have answered, the percentage of advance, it is the number of persons that have answered compared to the persons that have not. The answers may be presented by a bar chart with the answers, pie chart with the answers, or table with text answers.

Each one of the options may be displayed in an additional window (Pop up) or in the same control panel and may be configurable by the administrator. Options and sections may be linked to the session, and the session may be linked to another session, in order to identify each user's answer and use it in a different question

The session may be configured to change the answers. If the session may be configured to update the answers, the correction may be visualized in real time. The participant module may be accessed through web or an application. The participant may provide an answer, and the answer may appear in real time in the control panel that may be controlled by the administrator. All the information may be stored in a database for future use.

Further, the participant may enter an alphanumeric session code, and load predetermined questions with one or more answer configurations such as faces, stars, numbers, email, and so on. Questions may be changed of section, be random, and distributed in sections.

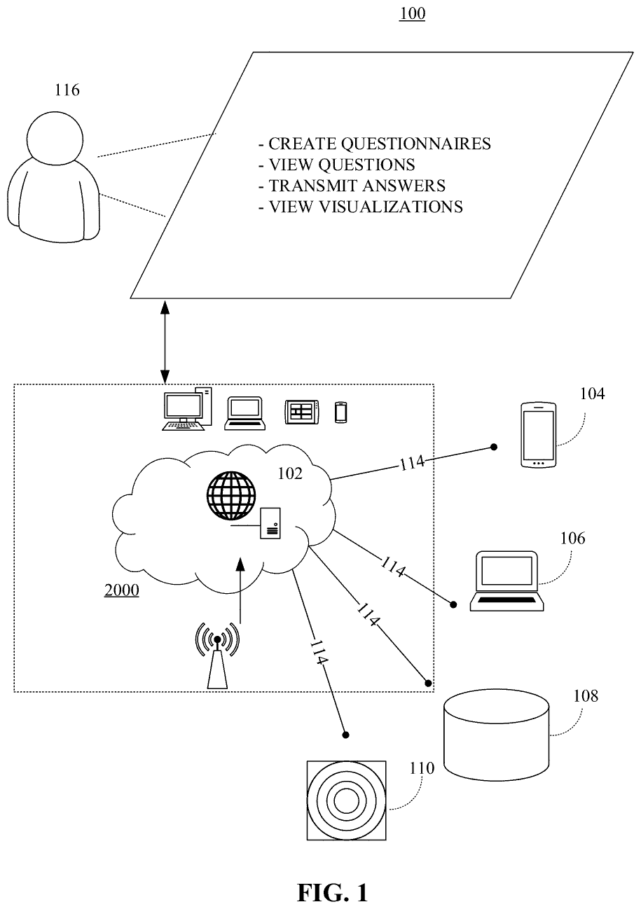

FIG. 1 is an illustration of an online platform 100 consistent with various embodiments of the present disclosure. By way of non-limiting example, the online platform 100 to facilitate provisioning of statistical data for a questionnaire may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 2000.

According to some embodiments, the online platform 100 may be configured to facilitate creation, transmission, and receipt of questionnaires, and answers thereof to and from multiple mobile devices, and generate real-time statistical data based on the received answers.

Further, the online platform 100 may communicate with one or more user devices. The one or more user devices may include one or more mobile devices such as, but not limited to, smartphones, computer tablets, laptops, and so on. The one or more user devices may include a communication device configured to communicate over a communication network such as, but not limited to, a cellular network, a satellite network, a personal area network, Bluetooth, Internet and so on. The one or more users of the online platform 100, such as one or more administrators, question askers, and reply providers, and so on, may use the one or more user devices to ask one or more questions through one or more questionnaires, and to provide one or more answers to the one or more questions in the questionnaires.

Further, the online platform 100 may allow users to register and create user profiles on the online platform 100. Accordingly, the user profiles may include administrator profiles, participant provider profiles, and administrator profiles connected to participant profiles. The user profiles created may include information about the name, age, gender, location, and so on of the users.

Further, the online platform 100 may allow an administrator to create one or more questionnaires. In an instance, the one or more questionnaires may be called as sessions. The one or more questionnaires may include one or more questions. Further, the one or more questionnaires may include multiple types of questions, such as poll questions, academic questions, and survey questions, and so on.

Further, the online platform 100 may allow one or more participants to answer the one or more questions in the one or more questionnaires. Accordingly, the online platform 100 may generate real-time visual statistical representation of the one or more answers. The real-time visual statistical representation of the one or more answers may include charts and graphs, such as pie charts and bar graphs, tabular representation, and so on.

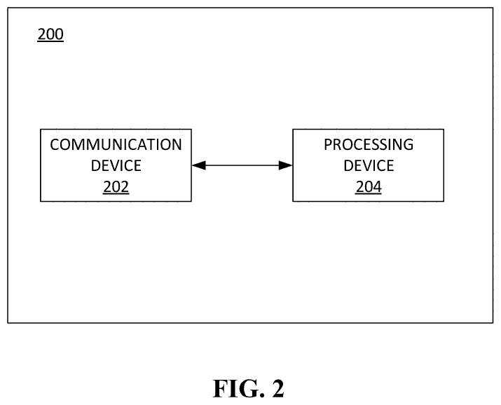

FIG. 2 is a block diagram representation of a system 200 to facilitate provisioning of statistical data for a questionnaire, in accordance with some embodiments. Accordingly, the system 200 may include a communication device 202 configured for receiving questionnaire data from at least one administrator device associated with at least one administrator. Further, in some embodiments, the questionnaire data may include at least one of an academic question, and a non-academic question. Further, in some embodiments, at least one of the academic question and the non-academic question may include a predefined answer format. Further, the predefined answer format may include at least one of a plurality of options as answers, and a blank field for answers.

Further, the communication device 202 may be configured for transmitting at least one questionnaire to one or more participant devices associated with one or more participants.

Further, the communication device 202 may be configured for receiving response data corresponding to the at least one questionnaire from the one or more participant devices. Further, in some embodiments, at least one of the questionnaire data, and the response data may be in at least one of a textual form, an audio form, and a visual form.

Further, the communication device 202 may be configured for transmitting a visual statistical representation to the at least one administrator device.

Further, the system 200 may include a processing device 204 configured for generating the at least one questionnaire based on the questionnaire data. Further, in some embodiments, the at least one questionnaire may include one or more questions related to one or more domains, topics, and field of knowledge.

Further, the processing device 204 may be configured for analyzing the response data to generate the visual statistical representation for the at least one questionnaire. Further, in some embodiments, the visual statistical representation may include at least one of a pie chart, a bar graph, a line chart, a histogram, a timeline chart, a cartogram, and a tree chart.

In some embodiments, the communication device 202 may be further configured for continuously receiving the response data from the one or more participant devices. Further, the processing device 204 may be configured for updating the visual statistical representation in real-time based on the continuously receiving.

In some embodiments, the communication device 202 may be further configured for transmitting the visual statistical representation to the one or more participant devices. Further, in some embodiments, the system 200 may include a storage device configured for storing the visual statistical representation for the at least one questionnaire in a database. Further, the database, in an instance may be configured to store all information in an organized form that may be electronically accessible. For instance, the database may include information such as (but not limited to) one or more questions sent previously in a session, one or more responses received from the one or more participants, the visual statistical representation, information received in all questions, and so on.

In some embodiments, the storage device may be configured for retrieving answer data corresponding to the at least one questionnaire from one or more external databases. Further, in some embodiment, the answer data may include one or more correct answers for one or more questions present in the at least one questionnaire. Further, in some embodiment, the one or more external databases may include at least one of a review aggregator, an encyclopedia, a university research database, and a government database. Further, the processing device 204 may be configured for analyzing the response data against the answer data corresponding to the at least one questionnaire to determine a correctness of the response data. Further, the processing device 204 may be configured for generating the visual statistical representation based on the correctness of the response data.

Further, in some embodiments, the questionnaire data may include participant device data associated with the one or more participant devices. Further, the participant device data may include an Internet Protocol (IP) address of the one or more participant devices. Further, in some embodiments, the at least one administrator may only be able to view the IP address associated with the one or more participant devices in order to maintain anonymity for the one or more participants. For instance, personal information (such as name, age, gender, etc.) associated with the one or more participants may be kept anonymous.

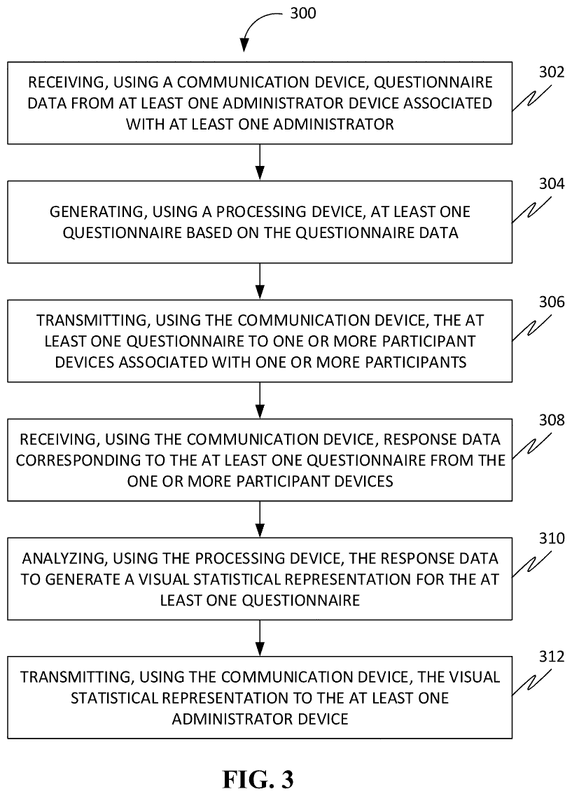

FIG. 3 is a flowchart of a method 300 to facilitate provisioning of statistical data for a questionnaire, in accordance with some embodiments. Accordingly, at 302, the method 300 may include receiving, using a communication device (such as the communication device 202), questionnaire data from at least one administrator device associated with at least one administrator. Further, in some embodiments, the questionnaire data may include at least one of an academic question, and a non-academic question. Further, in some embodiments, at least one of the academic question and the non-academic question may include a predefined answer format. Further, the predefined answer format may include at least one of a plurality of options as answers, and a blank field for answers.

Further, at 304, the method 300 may include generating, using a processing device (such as the processing device 204), at least one questionnaire based on the questionnaire data. Further, in some embodiments, the at least one questionnaire may include one or more questions related to one or more domains, topics, and field of knowledge.

Further, at 306, the method 300 may include transmitting, using the communication device, the at least one questionnaire to one or more participant devices associated with one or more participants.

Further, at 308, the method 300 may include receiving, using the communication device, response data corresponding to the at least one questionnaire from the one or more participant devices. Further, in some embodiments, at least one of the questionnaire data, and the response data may be in at least one of a textual form, an audio form, and a visual form.

Further, at 310, the method 300 may include analyzing, using the processing device, the response data to generate a visual statistical representation for the at least one questionnaire. Further, in some embodiments, the visual statistical representation may include at least one of a pie chart, a bar graph, a line chart, a histogram, a timeline chart, a cartogram, and a tree chart.

Further, at 312, the method 300 may include transmitting, using the communication device, the visual statistical representation to the at least one administrator device.

In some embodiments, the method 300 may further include transmitting, using the communication device, the visual statistical representation to the one or more participant devices.

Further, in some embodiments, the questionnaire data may include participant device data associated with the one or more participant devices. Further, the participant device data may include an Internet Protocol (IP) address of the one or more participant devices.

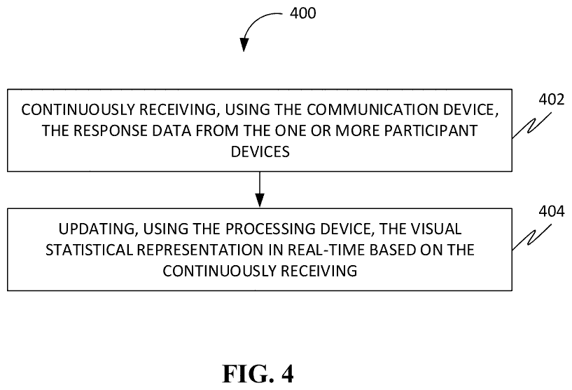

FIG. 4 is a flowchart of a method 400 to facilitate provisioning of visual statistical representation in real-time, in accordance with some embodiments. Accordingly, at 402, the method 400 may include continuously receiving, using the communication device, the response data from the one or more participant devices.

Further, at 404, the method 400 may include updating, using the processing device, the visual statistical representation in real-time based on the continuously receiving.

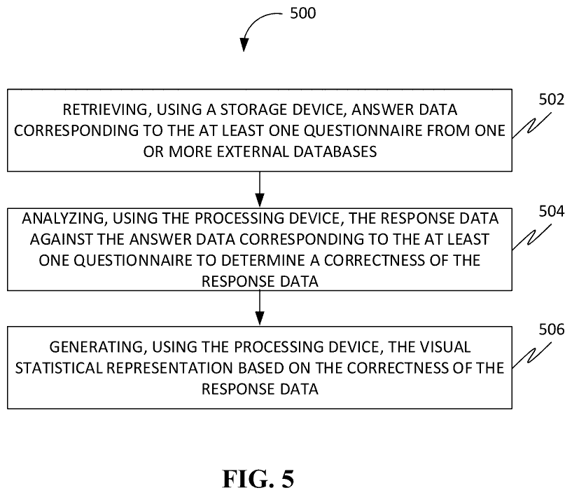

FIG. 5 is a flowchart of a method 500 to facilitate provisioning of visual statistical representation based on correctness of response, in some embodiments. Accordingly, at 502, the method 500 may include retrieving, using a storage device, answer data corresponding to the at least one questionnaire from one or more external databases. Further, in some embodiment, the answer data may include one or more correct answers for one or more questions present in the at least one questionnaire. Further, in some embodiment, the one or more external databases may include at least one of a review aggregator, an encyclopedia, a university research database, and a government database.

Further, at 504, the method 500 may include analyzing, using the processing device, the response data against the answer data corresponding to the at least one questionnaire to determine a correctness of the response data.

Further, at 506, the method 500 may include generating, using the processing device, the visual statistical representation based on the correctness of the response data.

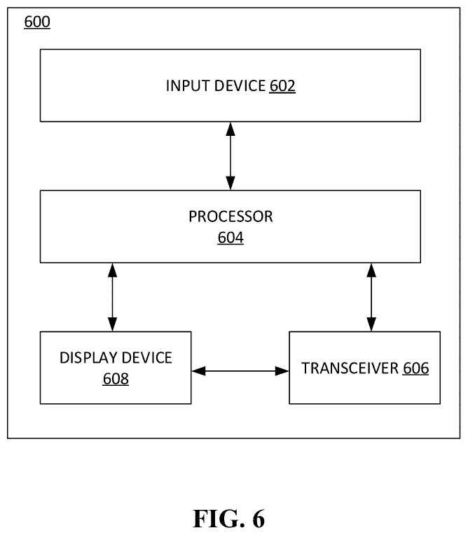

FIG. 6 is a block diagram representation of a system 600 to facilitate obtaining statistical data for at least one questionnaire at administrator side, in accordance with some embodiments. Accordingly, the system 600 may include an input device 602 configured for receiving questionnaire data from at least one administrator.

Further, the system 600 may include a processor 604 configured for generating at least one questionnaire based on the questionnaire data. Further, the processor 604 may be communicatively coupled with the input device 602.

Further, the processor 604 may be configured for analyzing response data corresponding to the at least one questionnaire to generate a visual statistical representation for the at least one questionnaire.

Further, the system 600 may include a transceiver 606 configured for transmitting the at least one questionnaire to one or more participant devices associated with one or more participants. Further, the transceiver 606 may be communicatively coupled with the processor 604.

Further, the transceiver 606 may be configured for receiving response data corresponding to the at least one questionnaire from the one or more participant devices.

Further, the system 600 may include a display device 608 configured for displaying the visual statistical representation to the at least one administrator. Further, the display device 608 may be communicatively coupled with the processor 604.

Further, in some embodiments, the transceiver 606 may be configured for transmitting the visual statistical representation to the one or more participant devices.

In some embodiments, the transceiver 606 may be configured for continuously receiving the response data from the one or more participant devices. Further, the processor 604 may be configured for updating the visual statistical representation in real-time based on the continuously receiving.

Further, in some embodiments, the system 600 may include a memory device configured for storing the visual statistical representation for the at least one questionnaire. Further, the memory device may be communicatively coupled with the processor 604.

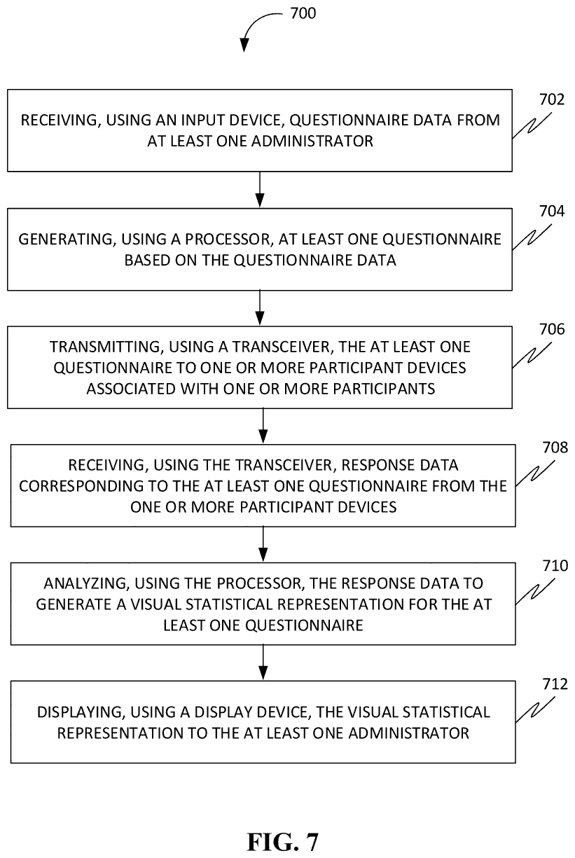

FIG. 7 is a flowchart of a method 700 to facilitate obtaining statistical data for at least one questionnaire at administrator side, in accordance with some embodiments. Accordingly, at 702, the method 700 may include receiving, using an input device (such as the input device 602), questionnaire data from at least one administrator.

Further, at 704, the method 700 may include generating, using a processor (such as the processor 604), at least one questionnaire based on the questionnaire data. Further, the processor may be communicatively coupled with the input device.

Further, at 706, the method 700 may include transmitting, using a transceiver (such as the transceiver 606), the at least one questionnaire to one or more participant devices associated with one or more participants. Further, the transceiver may be communicatively coupled with the processor.

Further, at 708, the method 700 may include receiving, using the transceiver, response data corresponding to the at least one questionnaire from the one or more participant devices.

Further, at 710, the method 700 may include analyzing, using the processor, the response data to generate a visual statistical representation for the at least one questionnaire.

Further, at 712, the method 700 may include displaying, using a display device (such as the display device 608), the visual statistical representation to the at least one administrator. Further, the display device may be communicatively coupled with the processor.

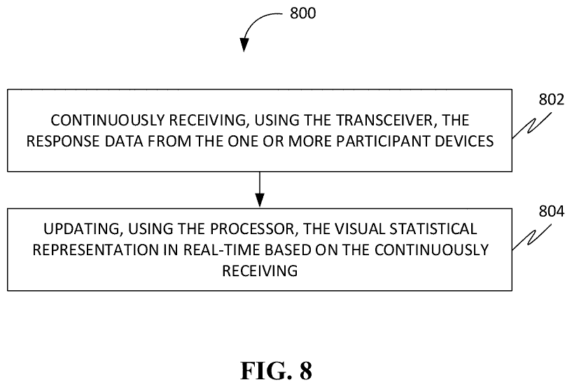

FIG. 8 is a flowchart of a method 800 to facilitate provisioning of visual statistical representation in real-time at administrator side, in accordance with some embodiments. Accordingly, at 802, the method 800 may include continuously receiving, using the transceiver, the response data from the one or more participant devices.

Further, at 804, the method 800 may include updating, using the processor, the visual statistical representation in real-time based on the continuously receiving.

Further, in some embodiments, the method 800 may include storing, using a memory device, the visual statistical representation for the at least one questionnaire. Further, the memory device may be communicatively coupled with the processor.

Further, in some embodiments, the method 800 may include transmitting, using the transceiver, the visual statistical representation to the one or more participant devices.

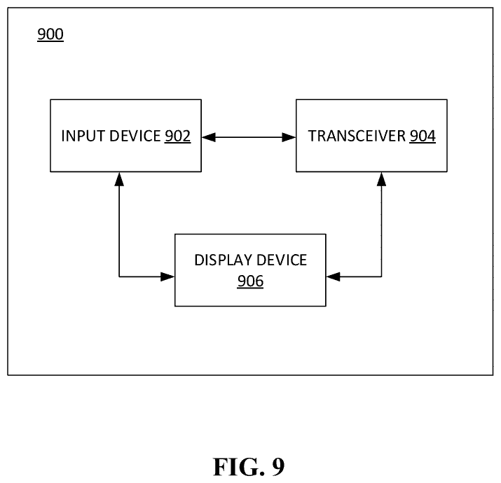

FIG. 9 is a block diagram representation of a system 900 to facilitate provisioning of responses for at least one questionnaire at a client side, in accordance with some embodiments. Accordingly, the system 900 may include a transceiver 904 configured for receiving at least one questionnaire from at least one administrator device.

Further, the transceiver 904 may be configured for transmitting response data to at least one administrator device.

Further, the system 900 may include a display device 906 configured for displaying the at least one questionnaire to one or more participants. Further, the display device 906 may be communicatively coupled with the transceiver 904.

Further, the system 900 may include an input device 902 configured for receiving the response data corresponding to the at least one questionnaire from the one or more participants.

In some embodiments, the transceiver 904 may be further configured for receiving a visual statistical representation for the at least one questionnaire from the at least one administrator device based on the transmitting of the response data. Further, the display device 906 may be configured for displaying the visual statistical representation to the one or more participants based on the receiving. Further, a memory device may be configured for storing the visual statistical representation for the at least one questionnaire. Further, the memory device may be communicatively coupled with the transceiver 904.

In some embodiments, the transceiver 904 may be further configured for continuously receiving one or more questions for the at least one questionnaire from the at least one administrator device. Further, the display device 906 may be configured for displaying the one or more questions of the at least one questionnaire in real-time to the one or more participants. Further, the transceiver 904 may be configured for continuously transmitting the response data for the one or more questions to the at least one administrator device.

Further, in some embodiments, the transceiver 904 may be configured for receiving a visual statistical representation in real-time from the at least one administrator device based on the continuously transmitting. Further, the display device 906 may be configured for displaying the visual statistical representation in real-time to the one or more participants based on the receiving.

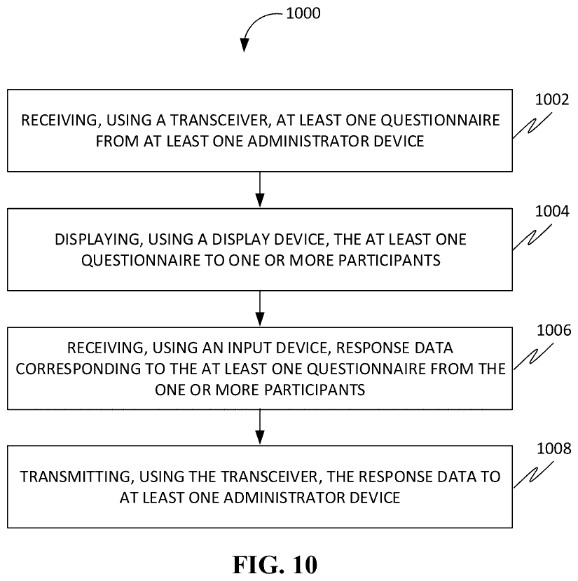

FIG. 10 is a flowchart of a method 1000 to facilitate provisioning of responses for at least one questionnaire at a client side, in accordance with some embodiments. Accordingly, at 1002, the method 1000 may include receiving, using a transceiver, at least one questionnaire from at least one administrator device.

Further, at 1004, the method 1000 may include displaying, using a display device, the at least one questionnaire to one or more participants. Further, the display device may be communicatively coupled with the transceiver.

Further, at 1006, the method 1000 may include receiving, using an input device, response data corresponding to the at least one questionnaire from the one or more participants.

Further, at 1008, the method 1000 may include transmitting, using the transceiver, the response data to at least one administrator device.

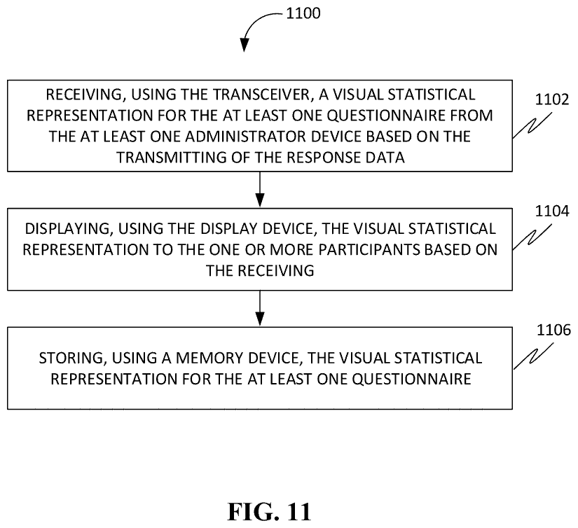

FIG. 11 is a flowchart of a method 1100 to facilitate provisioning of visual statistical representation for the at least one questionnaire at client side, in accordance with some embodiments. Accordingly, at 1102, the method 1100 may include receiving, using the transceiver, a visual statistical representation for the at least one questionnaire from the at least one administrator device based on the transmitting of the response data.

Further, at 1104, the method 1100 may include displaying, using the display device, the visual statistical representation to the one or more participants based on the receiving.

Further, at 1106, the method 1100 may include storing, using a memory device, the visual statistical representation for the at least one questionnaire. Further, the memory device may be communicatively coupled with the transceiver.

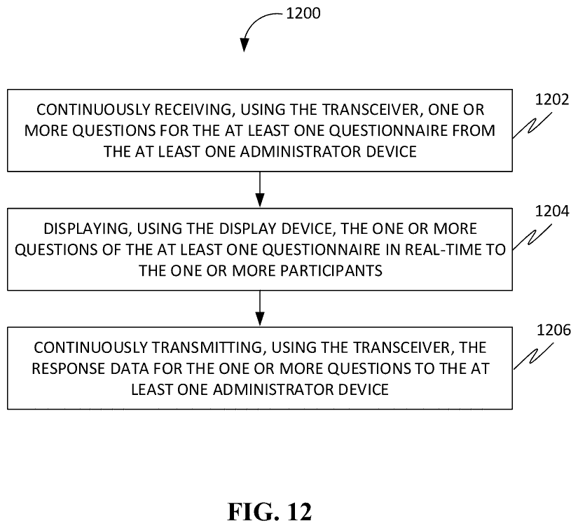

FIG. 12 is a flowchart of a method 1200 to facilitate provisioning of visual statistical representation in real-time at client side, in accordance with some embodiments. Accordingly, at 1202, the method 1200 may include continuously receiving, using the transceiver, one or more questions for the at least one questionnaire from the at least one administrator device.

Further, at 1204, the method 1200 may include displaying, using the display device, the one or more questions of the at least one questionnaire in real-time to the one or more participants.

Further, at 1206, the method 1200 may include continuously transmitting, using the transceiver, the response data for the one or more questions to the at least one administrator device.

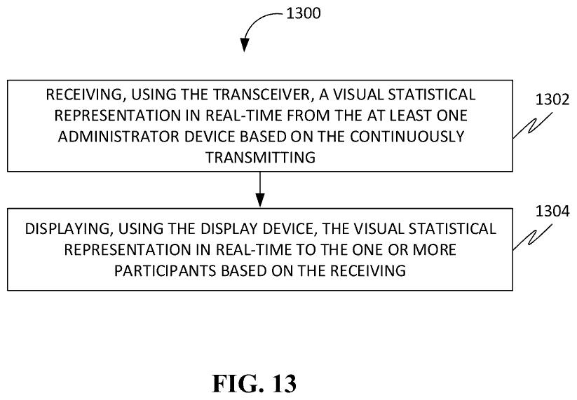

FIG. 13 is a flowchart of a method 1300 to facilitate presenting the visual statistical representation in real-time at client side, in accordance with some embodiments. Accordingly, at 1302, the method 1300 may include receiving, using the transceiver, a visual statistical representation in real-time from the at least one administrator device based on the continuously transmitting.

Further, at 1304, the method 1300 may include displaying, using the display device, the visual statistical representation in real-time to the one or more participants based on the receiving.

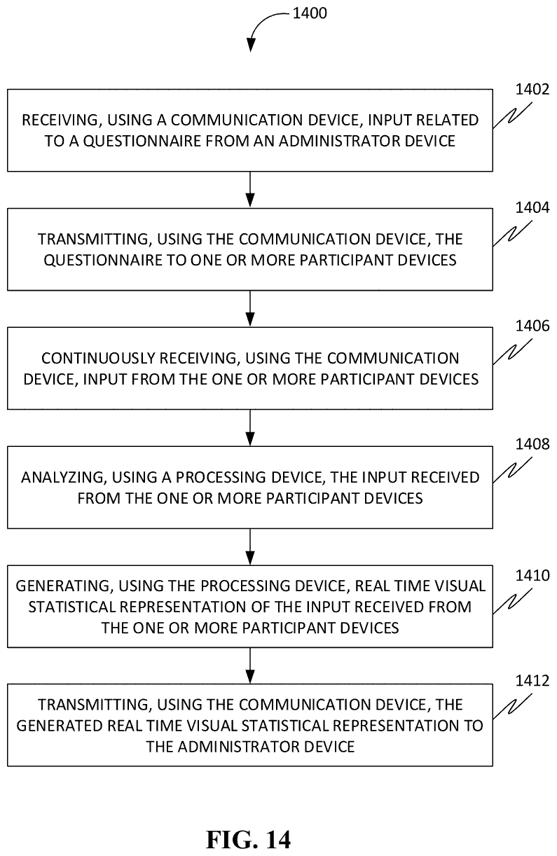

FIG. 14 is a flowchart of a method 1400 to facilitate creation, transmission, and receipt of questionnaires, and answers thereof to and from multiple mobile devices, and generate real-time statistical data based on the received answers, in accordance with some embodiments. Accordingly, at 1402, the method 1400 may include a step of receiving, using a communication device, input related to a questionnaire from an administrator device. The questionnaire may include one or more questions particular to one or more domains, and may include one or more associated answers. Accordingly, input related to the questionnaire may include one or more questions comprising the questionnaire. The questionnaire may include questions related to one or more domain, topics, and fields of knowledge. For instance, the questions may be academic, and may be related to economics, mathematics, geography, medicine, and so on. Further, the questions may be non-academic and may include survey questions, poll questions, review questions, and so on. Accordingly, the questions may include appropriate answer formats. For instance, academic questions may include multiple options as answers and may include one or more correct options. Further, the academic questions may include blank fields to type in respective answers. Further, poll questions may include multiple options from which one or more options may be selected. Further, survey questions may include multiple options that may correspond to one or more opinions, depending on the survey question. Further, input related to the questionnaire may include details about one or more user devices where the questionnaire may be transmitted. For instance, details about the one or more user devices may include IP addresses of the one or more user devices. In an instance, the input about the questionnaire may be received through an input mechanism of an administrator device such as, for example, a desktop computer, laptop computer, a tablet computer, a mobile device, and a wearable device. Further, administrator device may be configured to communicate with the communication device of a server computer. Accordingly, in an instance, the input about the questionnaire input through the input mechanism may be transmitted from the administrator device to the server computer.

Further, at 1404, the method 1400 may include transmitting, using the communication device, the questionnaire to one or more participant devices. The one or more participant devices may include one or more electronic devices such as desktop computers, laptop computers, tablet computers, mobile devices, and wearable devices such as smart-watches. Further, the participant devices may be located in a common geo-location or may be spread out over a large area. For instance, one or more participants associated with the one or more participant devices may include trainees, interns, or students. Accordingly, the one or more the participant devices may be located in the same room. Alternatively, one or more participants associated with the one or more participant devices may include customers using a particular product or service. Accordingly, the one or more the participant devices may be located over a city, state, or even a country. Further, the questionnaire may be transmitted to the one or more participant devices over a communication network such as, but not limited to, a cellular network, a satellite network, a personal area network, Bluetooth, Internet and so on. The communication network over which the questionnaire may be transmitted may vary depending on the location of the one or more participant devices.

Further, at 1406, the method 1400 may include continuously receiving, using the communication device, input from the one or more participant devices. The input may include answers to the one or more questions in the questionnaire. The answers may be in a format that may be in accordance with the one or more questions. For instance, if the one or more questions are objective type with multiple options, the answers may be received as a selection of one or more options as responses. Further, if the one or more questions require answers in one word or lines, the answers may be received as text responses. The answers may be continuously received as the one or more participants may not be able to answer the one or more questions instantly, and may answer the one or more questions at different times.

Further, at 1408, the method 1400 may include a step of analyzing, using a processing device, the input received from the one or more participant devices. The one or more inputs may be analyzed to determine statistical information related to the one or more inputs, and accordingly, the answers. For instance, the inputs may be analyzed to evaluate the received answers, and determine whether the answers may be correct or not. Alternatively, if the inputs are related to poll, or survey questions, the opinion provided in the one or more inputs as answers may be analyzed to determine the weightage of the one or more opinions received. Further, the received inputs may be analyzed to determine a number, and accordingly a percentage of the one or more participants who may have answered the one or more questions.

Further, at 1410, the method 1400 may include a step of generating, using the processing device, real-time visual statistical representation of the input received from the one or more participant devices. In an instance, the real-time visual statistical representation may include charts and graphs, such as pie charts and bar graphs, tabular representation, and so on. Accordingly, the visual statistical representation may be generated to display statistical information related to the one or more inputs, and accordingly, the answers. For instance, the visual statistical representation may display an analysis of the received answers, such as whether the answers may be correct or not. Alternatively, if the inputs are related to poll, or survey questions, the opinion provided in the one or more inputs as answers may be displayed using visual statistical representation. For instance, a pie chart may display the weightage of the one or more opinions received from the one or more participants. Further, the visual statistical representation may display a number, and accordingly a percentage of the one or more participants who may have answered the one or more questions. Further, the visual statistical representation may be constantly updated in real time, to display a real-time receipt of input from the one or more participant devices. For instance, if a pie chart displays a number, and accordingly a percentage of the one or more participants who may have answered the one or more questions, the pie chart may be updated in real time so as to display the updated percentage as more inputs are received from the one or more participant devices.

Further, at 1412, the method 1400 may include a step of transmitting, using the communication device, the generated real-time visual statistical representation to the administrator device. Further, the generated real-time visual statistical representation may be transmitted to the administrator device over a communication network such as, but not limited to, a cellular network, a satellite network, a personal area network, Bluetooth, Internet and so on.

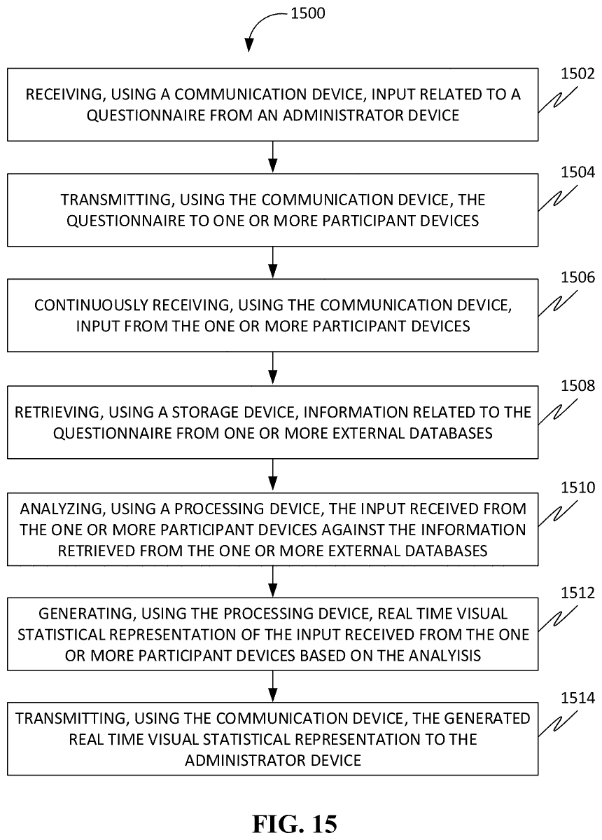

FIG. 15 is a flowchart of a method 1500 to validate the answers provided by one or more participants, in accordance with some embodiments. Accordingly, at 1502, the method 1500 may include a step of receiving, using a communication device, input related to a questionnaire from an administrator device. The questionnaire may include one or more questions particular to one or more domains and may include one or more associated answers. Accordingly, input related to the questionnaire may include one or more questions comprising the questionnaire. The questionnaire may include questions related to one or more domain, topics, and fields of knowledge. For instance, the questions may be academic, and may be related to economics, mathematics, geography, medicine, and so on. Further, the questions may be non-academic and may include survey questions, poll questions, review questions, and so on. Accordingly, the questions may include appropriate answer formats. For instance, academic questions may include multiple options as answers and may include one or more correct options. Further, the academic questions may include blank fields to type in respective answers. Further, poll questions may include multiple options from which one or more options may be selected. Further, survey questions may include multiple options that may correspond to one or more opinions, depending on the survey question. Further, input related to the questionnaire may include details about one or more user devices where the questionnaire may be transmitted. For instance, details about the one or more user devices may include IP addresses of the one or more user devices. In an instance, the input about the questionnaire may be received through an input mechanism of an administrator device such as, for example, a desktop computer, laptop computer, a tablet computer, a mobile device, and a wearable device. Further, administrator device may be configured to communicate with the communication device of a server computer. Accordingly, in an instance, the input about the questionnaire input through the input mechanism may be transmitted from the administrator device to the server computer.

Further, at 1504, the method 1500 may include transmitting, using the communication device, the questionnaire to one or more participant devices. The one or more participant devices may include one or more electronic devices such as desktop computers, laptop computers, tablet computers, mobile devices, and wearable devices such as smart-watches. Further, the participant devices may be located in a common geo-location or may be spread out over a large area. For instance, one or more participants associated with the one or more participant devices may include trainees, interns, or students. Accordingly, the one or more the participant devices may be located in a same room. Alternatively, one or more participants associated with the one or more participant devices may include customers using a particular product or service. Accordingly, the one or more the participant devices may be located over a city, state, or even a country. Further, the questionnaire may be transmitted to the one or more participant devices over a communication network such as, but not limited to, a cellular network, a satellite network, a personal area network, Bluetooth, Internet and so on. The communication network over which the questionnaire may be transmitted may vary depending on the location of the one or more participant devices.

Further, at 1506, the method 1500 may include continuously receiving, using the communication device, input from the one or more participant devices. The input may include answers to the one or more questions in the questionnaire. The answers may be in a format that may be in accordance with the one or more questions. For instance, if the one or more questions are objective type with multiple options, the answers may be received as a selection of one or more options as responses. Further, if the one or more questions require answers in one word or lines, the answers may be received as text responses. The answers may be continuously received as the one or more participants may not be able to answer the one or more questions instantly, and may answer the one or more questions at different times.

Further, at 1508, the method 1500 may include a step of retrieving, using a storage device, information related to the questionnaire from one or more external databases. Information related to the questionnaire may include answers to one or more questions included in the questionnaire. For instance, the questions may be academic, and may be related to economics, mathematics, geography, medicine, and so on. Accordingly, the information related to the questions may include answers to the one or more questions, which may be retrieved from one or more appropriate databases. Further, the questions may be non-academic and may include survey questions, poll questions, review questions, and so on. Accordingly, the information related to the one or more questions may include results of similar polls, or surveys conducted, that may be retrieved from one or more appropriate databases, such as review aggregator databases.

Further, at 1510, the method 1500 may include a step of analyzing, using a processing device, the input received from the one or more participant devices against the information retrieved from the one or more external databases. The one or more inputs may be analyzed to determine statistical information related to the one or more inputs, and accordingly, the answers. For instance, the inputs may be analyzed to evaluate the received answers, and determine whether the answers may be correct or not. Alternatively, if the inputs are related to poll, or survey questions, the opinion provided in the one or more inputs as answers may be analyzed to determine the weightage of the one or more opinions received. Further, the received inputs may be analyzed to determine a number, and accordingly a percentage of the one or more participants who may have answered the one or more questions. Further, the one or more inputs may be analyzed against the information retrieved from the one or more external databases. For instance, if the one or more questions are academic, the inputs may be analyzed against the information received from the one or more external databases to determine the correctness of the one or more answers. Further, if the one or more questions are non-academic, such as survey, or poll questions, the one or more inputs may be analyzed against results of similar polls and surveys conducted, and a deviation and variation from results retrieved from the one or more external databases may be determined.

Further, at 1512, the method 1500 may include a step of generating, using the processing device, real-time visual statistical representation of the input received from the one or more participant devices. In an instance, the real-time visual statistical representation may include charts and graphs, such as pie charts and bar graphs, tabular representation, and so on. Accordingly, the visual statistical representation may be generated to display statistical information related to the one or more inputs, and accordingly, the answers. For instance, the visual statistical representation may display an analysis of the received answers, such as whether the answers may be correct or not. Alternatively, if the inputs are related to poll, or survey questions, the opinion provided in the one or more inputs as answers may be displayed using visual statistical representation. For instance, a pie chart may display the weightage of the one or more opinions received from the one or more participants. Further, the visual statistical representation may display a number, and accordingly a percentage of the one or more participants who may have answered the one or more questions. Further, the visual statistical representation may be constantly updated in real time, to display a real-time receipt of input from the one or more participant devices. For instance, if a pie chart displays a number, and accordingly a percentage of the one or more participants who may have answered the one or more questions, the pie chart may be updated in real time so as to display the updated percentage as more inputs are received from the one or more participant devices.

Further, the visual statistical representation may include the information retrieved from the one or more external databases. For instance, if the one or more questions are academic, the visual statistical representation may display the correctness of the one or more answers. Further, if the one or more questions are non-academic, such as survey, or poll questions, the visual statistical representation may display a variation of the answers of the one or more questions from results retrieved from the one or more external databases may be determined.

Further, at 1514, the method 1500 may include a step of transmitting, using the communication device, the generated real-time visual statistical representation to the administrator device. Further, the generated real-time visual statistical representation may be transmitted to the administrator device over a communication network such as, but not limited to, a cellular network, a satellite network, a personal area network, Bluetooth, Internet and so on.

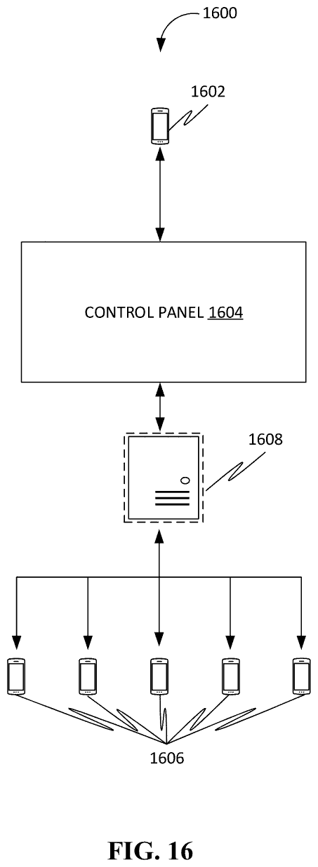

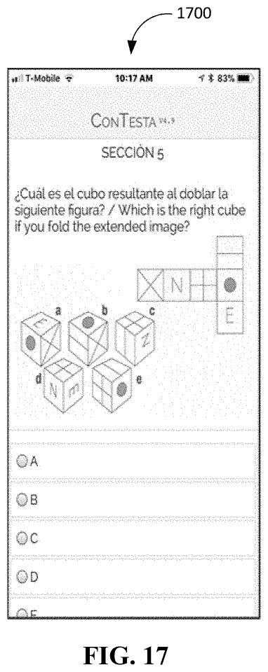

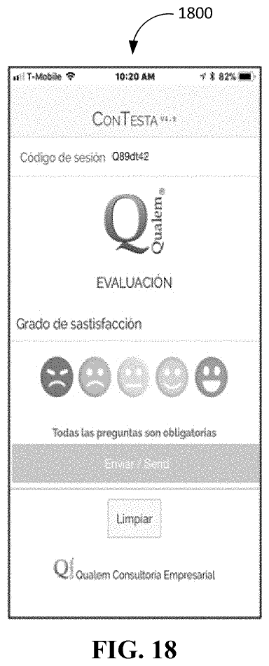

FIG. 16 is a block diagram of a system 1600 to facilitate creation, transmission, and receipt of questionnaires, and answers thereof to and from multiple mobile devices, and generate real-time statistical data based on the received answers, in accordance with some embodiments. Accordingly, the system 1600 may include an administrator device 1602 that may provide input related to a questionnaire through a control panel 1604. The questionnaire may include one or more questions particular to one or more domains and may include one or more associated answers. Accordingly, input related to the questionnaire may include one or more questions comprising the questionnaire. The questionnaire may include questions related to one or more domain, topics, and fields of knowledge. For instance, the questions may be academic, and may be related to economics, mathematics, geography, medicine, logical reasoning (as shown in FIG. 17), and so on. Further, the questions may be non-academic and may include survey questions (as shown in FIG. 18), poll questions, review questions, and so on. Accordingly, the questions may include appropriate answer formats. For instance, academic questions may include multiple options as answers and may include one or more correct options. Further, the academic questions may include blank fields to type in respective answers. Further, poll questions may include multiple options from which one or more options may be selected. Further, survey questions may include multiple options that may correspond to one or more opinions, depending on the survey question. Further, input related to the questionnaire may include details about one or more user devices where the questionnaire may be transmitted. For instance, details about the one or more user devices may include IP addresses of the one or more user devices. The administrator device 1602 may include a desktop computer, laptop computer, a tablet computer, a mobile device, a wearable device, and so on.

Further, the administrator device 1602 may generate an alphanumeric code to allow the questionnaire to be accessed by one or more participant devices 1606. Accordingly, the alphanumeric code may be transmitted to the one or more participant devices 1606 over a communication network, such as Wi-Fi, Bluetooth, and so on, through a personal message, or through an encrypted file.

Further, the system 1600 may include a cloud server 1608 that may be connected to the control panel 1604, and the one or more participant devices. In an instance, the control panel 1604 may authenticate the alphanumeric code in the one or more participant devices 1606 and validate the one or more participant devices 1606 to receive the questionnaire.

Yet further, in an instance, the administrator device 1602 may interface with the one or more participant devices 1606 and may authenticate the presence of the alphanumeric code in the one or more participant devices 1606 and validate the one or more participant devices 1606 to receive the questionnaire.

Accordingly, the input related to the questionnaire may be transmitted to the cloud server 1608 from the control panel 1604, and then to one or more participant devices 1606. The one or more participant devices 1606 may include one or more electronic devices such as desktop computers, laptop computers, tablet computers, mobile devices, and wearable devices such as smart-watches. Further, the one or more participant devices 1606 may be located in a common geo-location or may be spread out over a large area. For instance, one or more participants associated with the one or more participant devices 1606 may include trainees, interns, or students. Accordingly, the one or more the participant devices 1606 may be located in the same room. Alternatively, one or more participants associated with the one or more participant devices 1606 may include customers using a particular product or service. Accordingly, the one or more the participant devices 1606 may be located over a city, state, or even a country. Further, the questionnaire may be transmitted to the one or more participant devices 1606 over a communication network such as, but not limited to, a cellular network, a satellite network, a personal area network, Bluetooth, Internet and so on. The communication network over which the questionnaire may be transmitted may vary depending on the location of the one or more participant devices 1606.

Further, the one or more participant devices 1606 may continuously transmit, answers to the one or more questions in the questionnaire to the cloud server 1608. The answers may be in a format that may be in accordance with the one or more questions. For instance, if the one or more questions are objective type with multiple options, the answers may be received as a selection of one or more options as responses. Further, if the one or more questions require answers in one word or lines, the answers may be received as text responses. The answers may be continuously received as the one or more participants may not be able to answer the one or more questions instantly, and may answer the one or more questions at different times.

Further, the cloud server 1608 may analyze the answers received from the one or more participant devices 1606. The one or more answers may be analyzed to determine statistical information related to the one or more inputs, and accordingly, the answers. For instance, the answers may be analyzed to evaluate the correctness of the received answers, and determine whether the answers may be correct or not. Alternatively, if the answers are related to poll, or survey questions, the opinion provided in the one or more answers may be analyzed to determine the weightage of the one or more opinions received. Further, the received answers may be analyzed to determine a number, and accordingly a percentage of the one or more participants who may have answered the one or more questions.

Further, the cloud server 1608 may generate a real-time visual statistical representation of the answers received from the one or more participant devices 1606. In an instance, the real-time visual statistical representation may include charts and graphs, such as pie charts and bar graphs, tabular representation, and so on. Accordingly, the visual statistical representation may be generated to display statistical information related to the one or more answers. Further, the visual statistical representation may display a number, and accordingly a percentage of the one or more participants who may have answered the one or more questions. Further, the visual statistical representation may be constantly updated in real time, to display a real-time receipt of answers from the one or more participant devices. For instance, if a pie chart displays a number, and accordingly a percentage of the one or more participants who may have answered the one or more questions, the pie chart may be updated in real time so as to display the updated percentage as more inputs are received from the one or more participant devices 1606.

Further, the cloud server 1608 may transmit the generated real-time visual statistical representation to the administrator device 1602. Further, the generated real-time visual statistical representation may be transmitted to the administrator device 1602 over a communication network.

FIG. 17 is a screenshot of an exemplary user interface 1700 for a web-based application configured to provide one or more questionnaires to one or more participants, in accordance with some embodiments.

FIG. 18 is a screenshot of an exemplary user interface 1800 for a web-based application configured to provide one or more questionnaires to one or more participants, in accordance with some embodiments.

FIG. 19 is a screenshot of an exemplary user interface 1900 for a web-based application at least one administrator, in accordance with some embodiments.

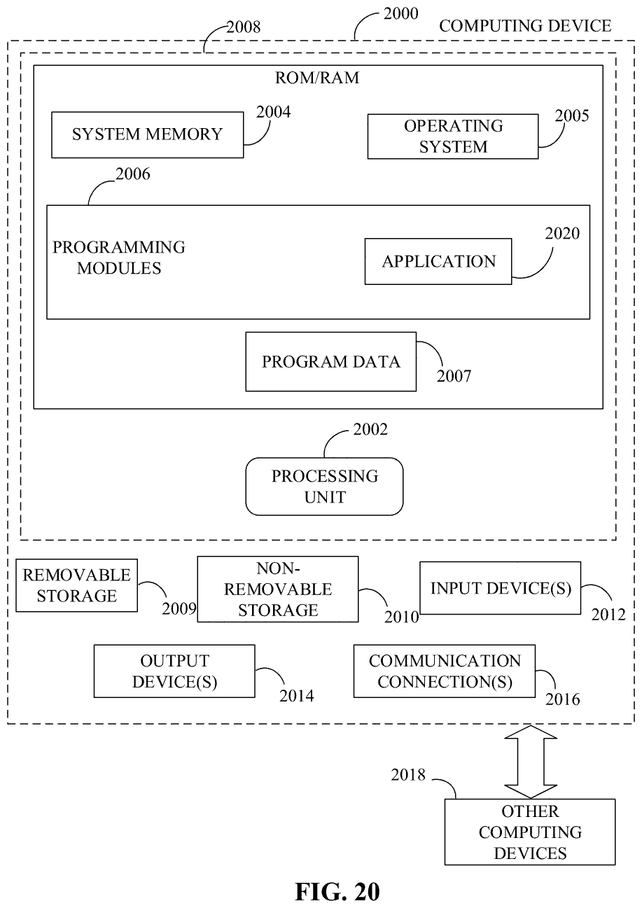

With reference to FIG. 20, a system consistent with an embodiment of the disclosure may include a computing device or cloud service, such as computing device 2000. In a basic configuration, computing device 2000 may include at least one processing unit 2002 and a system memory 2004. Depending on the configuration and type of computing device, system memory 2004 may comprise, but is not limited to, volatile (e.g. random-access memory (RAM)), non-volatile (e.g. read-only memory (ROM)), flash memory, or any combination. System memory 2004 may include operating system 2005, one or more programming modules 2006, and may include a program data 2007. Operating system 2005, for example, may be suitable for controlling computing device 2000's operation. In one embodiment, programming modules 2006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 20 by those components within a dashed line 2008.

Computing device 2000 may have additional features or functionality. For example, computing device 2000 may also include additional data storage devices (removable and/or non-removable) such as, for example, magnetic disks, optical disks, or tape. Such additional storage is illustrated in FIG. 20 by a removable storage 2009 and a non-removable storage 2010. Computer storage media may include volatile and non-volatile, removable and non-removable media implemented in any method or technology for storage of information, such as computer-readable instructions, data structures, program modules, or other data. System memory 2004, removable storage 2009, and non-removable storage 2010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2000. Any such computer storage media may be part of device 2000. Computing device 2000 may also have input device(s) 2012 such as a keyboard, a mouse, a pen, a sound input device, a touch input device, a location sensor, a camera, a biometric sensor, etc. Output device(s) 2014 such as a display, speakers, a printer, etc. may also be included. The aforementioned devices are examples and others may be used.

Computing device 2000 may also contain a communication connection 2016 that may allow device 2000 to communicate with other computing devices 2018, such as over a network in a distributed computing environment, for example, an intranet or the Internet. Communication connection 2016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2004, including operating system 2005. While executing on processing unit 2002, programming modules 2006 (e.g., application 2020 such as a media player) may perform processes including, for example, one or more stages of methods, algorithms, systems, applications, servers, databases as described above. The aforementioned process is an example, and processing unit 2002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method to facilitate provisioning of statistical data for a questionnaire, wherein the method comprises:
receiving, using a communication device, questionnaire data from at least one administrator device associated with at least one administrator;
generating, using a processing device, at least one questionnaire based on the questionnaire data;
transmitting, using the communication device, the at least one questionnaire to one or more participant devices associated with one or more participants;
receiving, using the communication device, response data corresponding to the at least one questionnaire from the one or more participant devices;
analyzing, using the processing device, the response data to generate a visual statistical representation for the at least one questionnaire; and
transmitting, using the communication device, the visual statistical representation to the at least one administrator device.

2. The method of claim 1 further comprising transmitting, using the communication device, the visual statistical representation to the one or more participant devices.

3. The method of claim 1, wherein the questionnaire data comprises at least one of an academic question, and a non-academic question.

4. The method of claim 3, wherein at least one of the academic question and the non-academic question comprises a predefined answer format, wherein the predefined answer format comprises at least one of a plurality of options as answers, and a blank field for answers.

5. The method of claim 1, wherein the at least one questionnaire comprises one or more questions related to one or more domains, topics, and field of knowledge.

6. The method of claim 1, wherein the visual statistical representation comprises at least one of a pie chart, a bar graph, a line chart, a histogram, a timeline chart, a cartogram, and a tree chart.

7. The method of claim 1, wherein at least one of the questionnaire data, and the response data is in at least one of a textual form, an audio form, and a visual form.

8. The method of claim 1 further comprises:
continuously receiving, using the communication device, the response data from the one or more participant devices; and
updating, using the processing device, the visual statistical representation in real-time based on the continuously receiving.

9. The method of claim 1 further comprises:
retrieving, using a storage device, answer data corresponding to the at least one questionnaire from one or more external databases;
analyzing, using the processing device, the response data against the answer data corresponding to the at least one questionnaire to determine a correctness of the response data; and
generating, using the processing device, the visual statistical representation based on the correctness of the response data.

10. The method of claim 9, wherein the answer data comprises one or more correct answers for one or more questions present in the at least one questionnaire.

11. The method of claim 9, wherein the one or more external databases comprise at least one of a review aggregator, an encyclopedia, a university research database, and a government database.

12. The method of claim 1, wherein the questionnaire data comprises participant device data associated with the one or more participant devices, wherein the participant device data comprises an Internet Protocol (IP) address of the one or more participant devices.

13. A method to facilitate obtaining statistical data for a questionnaire, wherein the method comprises:
receiving, using an input device, questionnaire data from at least one administrator;
generating, using a processor, at least one questionnaire based on the questionnaire data, wherein the processor is communicatively coupled with the input device;
transmitting, using a transceiver, the at least one questionnaire to one or more participant devices associated with one or more participants, wherein the transceiver is communicatively coupled with the processor;
receiving, using the transceiver, response data corresponding to the at least one questionnaire from the one or more participant devices;
analyzing, using the processor, the response data to generate a visual statistical representation for the at least one questionnaire; and
displaying, using a display device, the visual statistical representation to the at least one administrator, where in the display device is communicatively coupled with the processor.

14. The method of claim 13 further comprising:
continuously receiving, using the transceiver, the response data from the one or more participant devices; and
updating, using the processor, the visual statistical representation in real-time based on the continuously receiving.

15. The method of claim 13 further comprising storing, using a memory device, the visual statistical representation for the at least one questionnaire, wherein the memory device is communicatively coupled with the processor.

16. The method of claim 13 further comprising transmitting, using the transceiver, the visual statistical representation to the one or more participant devices.

17. A method to facilitate provisioning of responses for a questionnaire, wherein the method comprises:
receiving, using a transceiver, at least one questionnaire from at least one administrator device;
displaying, using a display device, the at least one questionnaire to one or more participants, wherein the display device is communicatively coupled with the transceiver;
receiving, using an input device, response data corresponding to the at least one questionnaire from the one or more participants; and
transmitting, using the transceiver, the response data to at least one administrator device.

18. The method of claim 17 further comprising:
receiving, using the transceiver, a visual statistical representation for the at least one questionnaire from the at least one administrator device based on the transmitting of the response data;
displaying, using the display device, the visual statistical representation to the one or more participants based on the receiving; and
storing, using a memory device, the visual statistical representation for the at least one questionnaire, wherein the memory device is communicatively coupled with the transceiver.

19. The method of claim 17 further comprising:
continuously receiving, using the transceiver, one or more questions for the at least one questionnaire from the at least one administrator device;
displaying, using the display device, the one or more questions of the at least one questionnaire in real-time to the one or more participants; and
continuously transmitting, using the transceiver, the response data for the one or more questions to the at least one administrator device.

20. The method of claim 19 further comprising:
receiving, using the transceiver, a visual statistical representation in real-time from the at least one administrator device based on the continuously transmitting; and
displaying, using the display device, the visual statistical representation in real-time to the one or more participants based on the receiving.
